(19) United States
(12) Patent Application Publication
(10) Pub. No.: US 2008/0187722 A1
(43) Pub. Date: Aug. 7, 2008

(54) METHOD FOR DESIGNING A LEADLESS CHIP CARRIER

(76) Inventor: Jaime I. Waldman, Pittsford, NY (US)

Correspondence Address: Frank Pincelli;Patent Legal Staff, Eastman Kodak Company, 343 State Street, Rochester, NY, 14650-2201, US

(21) Appl. No.: 11/672,258

(22) Filed: Feb. 7, 2007

(51) Int. Cl. B32B 33/00; B23K 31/02

(52) U.S. Cl. 428/192; 228/180.22

(57) ABSTRACT

A method for surface mounting a leadless chip carrier to a circuit board, the method includes the steps of providing the leadless chip carrier with chamfered edges along one or more sides and with package metallic connection portions disposed along one or more chamfered edges; providing the circuit board with a plurality of circuit board metallic connection portions; placing a layer of solder onto the circuit board metallic connection; placing the leadless chip carrier on the circuit board with the package metallic connections, layer of solder and the circuit board metallic connections aligned; and heating the leadless chip carrier and the circuit board so the layer of solder forms a solder joint with the package metallic connection portions and the circuit board metallic connections.

### FIELD OF THE INVENTION

The invention relates generally to the field of image sensor packaging, and more particularly, to providing chamfered edges on the image sensor package to enhance mounting of the package to a circuit board.

### BACKGROUND OF THE INVENTION

Referring to FIGS. 1 and 2, currently, image sensors 10 include a plurality of pixels 20 housed in a rectangular enclosure 30, commonly referred to as a ceramic package, having sides 40 that extend perpendicular from the top of the enclosure 30. Metal contacts 50 extend downwardly along the sides of the enclosure. Referring to FIG. 3, the image sensor is placed on a circuit board 60 by soldering 70 and the like.

Although the current method is satisfactory, improvements in the packaging method are always desirable.

### SUMMARY OF THE INVENTION

The present invention is directed to overcoming one or more of the problems set forth above. Briefly summarized, according to one aspect of the present invention, the present invention resides in a method for surface mounting a leadless chip carrier to a circuit board, the method comprising the steps of providing the leadless chip carrier with chamfered edges along one or more sides and with package metallic connection portions disposed along one or more chamfered edges; providing the circuit board with a plurality of circuit board metallic connection portions; placing a layer of solder onto the circuit board metallic connection; placing the leadless chip carrier on the circuit board with the package metallic connections, layer of solder and the circuit board metallic connections aligned; and heating the leadless chip carrier and the circuit board so the layer of solder forms a solder joint with the package metallic connection portions and the circuit board metallic connections.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the following advantages of reduced stress points acting on the solder joint during temperature cycling of the package that is soldered to a circuit board. This reduced stress will reduce the creation of solder cracking.

The coefficient of thermal expansion (CTE) of the ceramic package, preferably alumina (Al₂O₃), is approximately 7 ppm per degree C. and typical circuit board material is 1.5× to over 2× the coefficient of thermal expansion. The soldering process firmly attaches the electronic package to the circuit board creating an assembly. When the assembly is heated or cooled, the variation in CTE causes stress to be created at the solder joints. Cycling the assembly from cold (−40 C) to hot (+85) can fatigue the solder joints and induce stress cracks in the solder. The stress cracks create open circuit, which render the circuit board defective. The no lead solders are more brittle than leaded versions and hence they will have a higher propensity to crack.

The prior art ceramic surface mount packages have a sharp edge. This edge is a stress concentration point that will be a crack generation point. In contrast, the chamfered edge of the present invention allows for a reduced stress concentration area over the sharp edge of the prior art ceramic surface mount package. Modeling has shown that this reduction in stress concentration will allow the solder to survive thermal cycling beyond what can be achieved with the current sharp edges. The modeling data reveals at least a 6× improvement can be obtained.

### BRIEF DESCRIPTION OF THE DRAWINGS

FIG. 1 is a top view of a prior art image sensor and its associated ceramic package;

FIG. 2 is a side view of FIG. 1;

FIG. 3 is a cross sectional view of FIG. 1;

FIG. 4 is a top view of the image sensor of the present invention;

FIG. 5 is a side view of FIG. 4;

FIG. 6 is a cross sectional view of FIG. 4; and

FIG. 7 is a top view of the circuit board of the present invention.

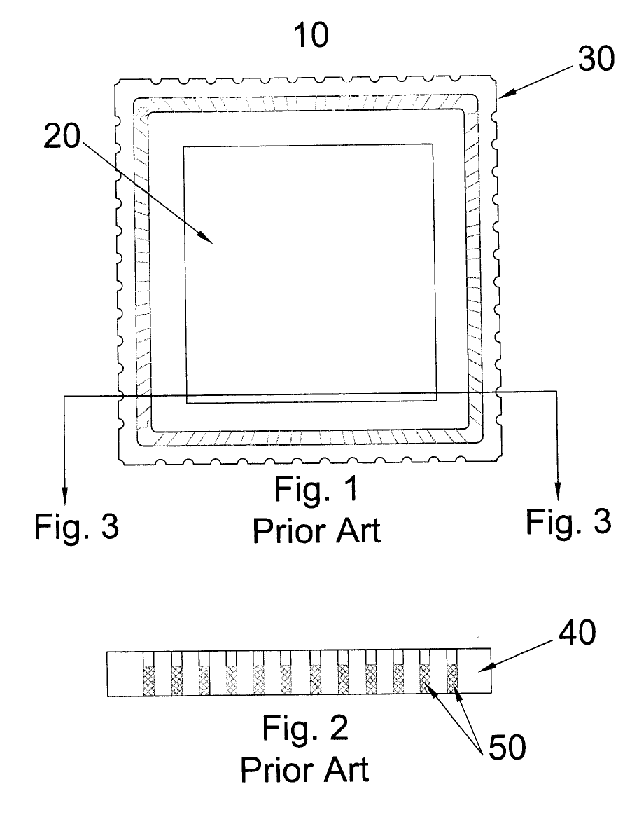

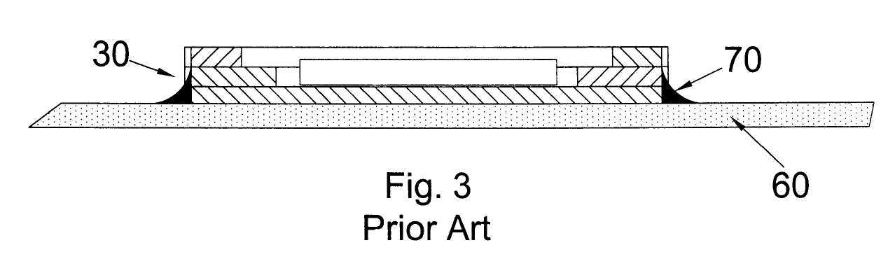

### DETAILED DESCRIPTION OF THE INVENTION

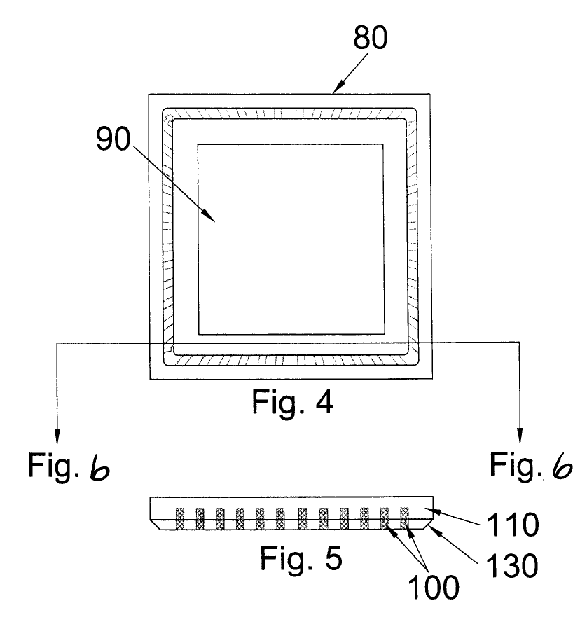

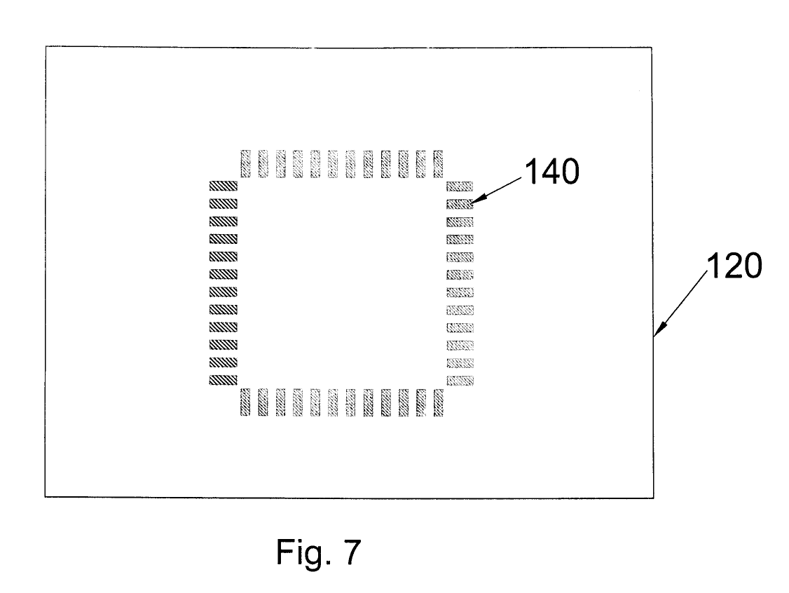

Referring to FIG. 4, there is shown a top view of the leadless, ceramic chip carrier 80 of the present invention. The carrier includes a plurality of pixels 90 arranged in a two dimensional array for collecting charge, preferably electrons, in response to light. The pixels 90 are packaged in the leadless, ceramic chip carrier 80 which surrounds the pixels 90. Referring to FIG. 5, a plurality of metallic contacts 100 are disposed along one or more sides 110, typically all four sides, that form electrical connections between the leadless, ceramic chip carrier 80 and a circuit board 120 (see FIG. 7) which will be attached thereto. Although the sides 110 shown a straight edge, the sides 110 could have castellations. All four sides preferably include a chamfered edge 130 which facilitates efficient attachment to the circuit board 120, as will be described hereinbelow. The chamfered edge 130 is preferably forty-five degrees or substantially between thirty degrees and sixty degrees.

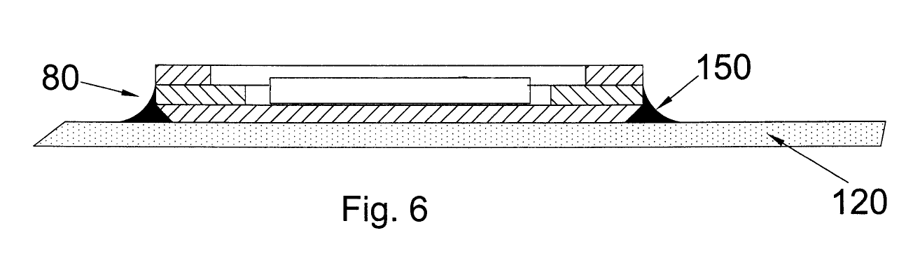

Referring to FIG. 6, there is shown the leadless, ceramic chip carrier 80 attached to the circuit board 120. The circuit board 120 includes a two-dimensional substrate having a plurality of metallic contacts 140 (see FIG. 7) that spatially align with the metallic contacts 100 of the leadless, ceramic chip carrier 80.

Referring to FIG. 6, the leadless, ceramic chip carrier 80 is attached by either of two methods. The first method includes placing a layer of solder 150 on the metallic contacts 140 (see FIG. 7) of the circuit board 120. The leadless, ceramic chip carrier 80 is positioned on the circuit board 120 so that the metallic contacts 100 of the leadless, ceramic chip carrier 80, solder 150 and metallic contacts 140 of the circuit board are aligned in a one-to-one relationship. This entire assembly is heated so that the solder 150 melts and eventually spreads out to form a joint for the chip carrier 80 along its chamfered edges 130 and the circuit board 120. The second method preferably includes the circuit board 120 and the chip carrier 80 having their respective metal contacts 100 and 140 aligned. The chip carrier 80 is then placed atop the circuit board 120 with the metallic connections 100 and 140 spatially aligned in a one-to-one relationship. The interface formed by the metallic contacts 100 and 140 have molten solder applied which causes a soldered joint along the chamfered edges 130 and the circuit board 120.

The invention has been described with reference to a preferred embodiment. However, it will be appreciated that variations and modifications can be effected by a person of ordinary skill in the art without departing from the scope of the invention.

### PARTS LIST

10 prior art image sensor
20 pixels
30 prior art image sensor package
40 sides of package
50 package metal contacts
60 circuit board
70 solder
80 leadless, ceramic chip carrier
90 pixels
100 metallic contacts on package
110 sides of package
120 circuit board
130 chamfered edges
140 circuit board metallic contacts
150 solder

1. A method for surface mounting a leadless chip carrier to a circuit board, the method comprising the steps of:
(a) providing the leadless chip carrier with chamfered edges along one or more sides and with package metallic connection portions disposed along one or more chamfered edges;
(b) providing the circuit board with a plurality of circuit board metallic connection portions;
(c) placing a layer of solder onto the circuit board metallic connection;
(d) placing the leadless chip carrier on the circuit board with the package metallic connections, layer of solder and the circuit board metallic connections aligned; and
(e) heating the leadless chip carrier and the circuit board so the layer of solder forms a solder joint with the package metallic connection portions and the circuit board metallic connections.

2. The method as in claim 1, wherein step (a) includes providing a leadless chip carrier packaged image sensor as the leadless chip carrier.

3. The method as in claim 2, wherein step (a) includes providing substantially forty-five degree angles forming the chamfered edges.

4. The method as in claim 2, wherein step (a) includes providing a range of substantially between angles of thirty degrees and sixty degrees for forming the chamfered edges.

5. A surface mount assembly comprising:
(a) a leadless chip carrier with chamfered edges along one or more sides and with metallic connection portions disposed along one or more chamfered edges; and
(b) a circuit board with a plurality of solder pads; wherein the leadless chip carrier and the circuit board have solder joints at an aligned connection of the solder pads to the metallic connection portions of the leadless chip carrier.

6. The surface mount assembly as in claim 5, wherein the leadless chip carrier is a leadless chip carrier packaged image sensor.

7. The surface mount assembly as in claim 6, wherein the chamfered edges are substantially forty-five degree angles.

8. The surface mount assembly as in claim 6, wherein the chamfered edges are substantially between a range of thirty degrees and sixty degrees.

9. A method for surface mounting a leadless chip carrier to a circuit board, the method comprising the steps of:
(a) providing the leadless chip carrier with chamfered edges along one or more sides and with package metallic connection portions disposed along one or more chamfered edges;
(b) providing the circuit board with a plurality of circuit board metallic connection portions;
(c) placing the leadless chip carrier on the circuit board with the package metallic connections and the circuit board metallic connections aligned for forming an interface; and
(d) applying solder to the interface.

10. The method as in claim 9, wherein step (a) includes providing a leadless chip carrier packaged image sensor as the leadless chip carrier.

11. The method as in claim 10, wherein step (a) includes providing substantially forty-five degree angles forming the chamfered edges.

12. The method as in claim 10, wherein step (a) includes providing a range of substantially between angles of thirty degrees and sixty degrees for forming the chamfered edges.
